(19) United States
(12) Patent Application Publication
(10) Pub. No.: US 2001/0021999 A1
(43) Pub. Date: Sep. 13, 2001

(54) Method and device for transmitting data units of a data stream

(76) Inventor: Nils Seifert, Berlin (DE)

Correspondence Address: SMITH PATENT OFFICE, 1901 PENNSYLVANIA AVENUE N W, SUITE 200, WASHINGTON, DC, 20006

(21) Appl. No.: 09/774,052

(22) Filed: Jan. 31, 2001

(30) Foreign Application Priority Data
Jan. 31, 2000 (DE) DE 100 04 829.3

(51) Int. Cl. H04N 7/173

(52) U.S. Cl. 725/87

(57) ABSTRACT

The invention relates to a method and a device for transmitting a data stream, especially a multimedia data stream, from at least one transmitting facility to at least one receiving facility. In this method, the data stream is split into data units. At successive times, in each case at least a part of the data units is transmitted in such a manner that the at least one receiving facility can begin complete reception of the data stream at any of the successive times.

### BACKGROUND OF THE INVENTION

1. Field of the Invention

The invention relates to a method and a device for transmitting data units of a data stream, especially a multimedia data stream from at least one transmitting facility to at least one receiving facility.

2. Discussion of the Related Art

Today's world of entertainment and dissemination of information cannot be imagined without the transmission of real-time media which includes, in particular, the transmission associated with radio broadcasting and television. When he uses these media, however, the consumer still has to accept restrictions at present: the transmissions begin at fixed times and can also be only viewed or “called up” at these fixed times unless video recorders are used.

Some years ago, field trials have been conducted, therefore, involving, among other parties, the Deutsche Telekom AG, where the use of modern communication technology was provided for implementing “video-on-demand”. This is a media service in which each customer individually selects the time when he wishes to view a particular programme (feature film, concert transmission etc.) with the aid of his television set. “Video-on-demand” places very high demands on the technical infrastructure used for it. For example, this relates to the video servers with the aid of which the retrievable media contents are made available and the communication bandwidth necessary when the retrievable media contents are transmitted to a receiving set of the customer. “Video-on-demand” has not, therefore, been previously used in the mass market.

Today, a (“time-independent”) individual selectability of media contents mainly only exists in the domain of the Internet (apart from video cassette rental). Media servers deliver individual media contents to the users or customers controlled via Internet pages or other graphical user interfaces.

The methods for the transmission of media contents or multimedia data streams hitherto used in the media domain (for example in television or radio) firstly comprise the abovementioned usual method in which a programme is transmitted “live” to all possible receivers at a fixed transmitting time.

This is different from a transmission on demand, for example “video-on-demand”. In this method, it is necessary that the multimedia data stream is transmitted separately for each receiver, for example via ATM, in which arrangement the transmission can be begun on demand, i.e. at a time which can be determined individually. However, the transmission on demand has the disadvantage that a separate transmission must be performed potentially for each receiver. This increases the necessary total transmission bandwidth of the transmitter in proportion to the number of receivers to be served simultaneously so that this method cannot be used for a large number of receivers, or only with a great expenditure.

In a transmission which is almost on demand and which is also called “near video-on-demand”, a number of receivers are combined to form one group. For these receivers, a single joint transmission of the multimedia data stream then takes place. In this method, groups of receivers which would like to retrieve the multimedia data stream within a predetermined period are combined and the transmission of the multimedia data stream begins jointly for all receivers after the predetermined period has elapsed. However, transmission to groups of receivers has the disadvantage that at least some receivers must potentially wait a very long time for the beginning of transmission (if there are few transmissions to a large number of receivers) or the total transmission bandwidth of the transmitter is very large if many transmissions of small groups of receivers are provided.

A periodic transmission method is also known. In the case of a large number of receivers, the transmission requests would have to be processed individually. To avoid this, it may be appropriate to transmit the multimedia data stream or the media content periodically right from the start. A receiver must then wait for the beginning of the next transmission of the multimedia data stream. To enable the receivers to begin retrieval at predetermined times, the complete multimedia data stream must be transmitted in each case on a number of channels beginning at the possible retrieval times. Periodic transmission has, therefore, the disadvantage that the total transmission bandwidth of the transmitter must be very large, especially if it is intended to provide an adequate number of retrieval start times. Otherwise, the receivers have to wait for a very long time for the beginning of transmission.

Another known method provides that the multimedia data stream is received and stored by the receiver of the consumer at a time at which no reproduction is intended. The automatically stored multimedia data stream can be reproduced later at any time. Storage can in this case be performed selectively for individual multimedia data streams or be permanent. The method of reproducing a stored transmission has the disadvantage, however, that the receiver must select the reception in advance and must have adequate storage capacity.

### SUMMARY OF THE INVENTION

An object of the present invention is to create an improved method of the type initially mentioned, in which the disadvantages described are at least partially overcome.

The object is achieved by a method according to claim 1 and a device according to claim 14.

The essential advantage achieved by means of the invention, compared with the prior art, consists in that a method is created by means of which a data stream, especially a multimedia data stream, of arbitrary length is transmitted in such a manner that an arbitrary number of consumers are enabled to receive and to consume the data stream independently of one another at different times with the aid of their respective receivers.

Furthermore, an essential aspect of the method according to the invention consists in that the total quantity of the data to be transmitted between the transmitting facility and the receiving facilities does not rise proportionally with the number of receiving facilities. This saves transmission capacities so that the costs are lowered and “video-on-demand” also becomes usable for the mass market.

A data stream transmitted in accordance with the method can be designed as a part of a “higher-level” total data stream.

Fields of application for the method include all applications in which any types of audio/video or other data streams (television, radio, media-on-demand and business TV but also streaming data such as stock market teleprinter etc.) are distributed via satellites, cable networks or the like to groups of consumers with their respective receiving facilities, and the consumers are intended to have the possibility of being able to choose between data streams.

Furthermore, there are the following advantages in conjunction with the novel method for transmitting data units:

Entry into a transmission of a multimedia data stream is possible at an (almost arbitrary) time, the granularity of the entry points being dependent on a number of parameters which can be set per media data stream, per group of customers etc.

The viewing or, respectively, consumption of the multimedia data stream output at the consumer can be interrupted for an arbitrary period of time.

“Fast forward” and “skipping of parts” after an interruption are possible.

It is possible to provide different variants of the same programme (for instance a feature film in two modes: with a happy and a tragic end) for the consumers.

Transmission with different amounts of advertising, with customer-related advertising etc. is possible.

A suitable further development of the invention provides that an input of a user of the at least one receiving facility Eⱼ for establishing the time t₁ and/or the time tₖ (2≦k≦n) is electronically detected, the input being transmitted to the at least one transmitting facility via a return data channel formed between the at least one transmitting facility and the at least one receiving facility Eₘ. As a result, the beginning of the transmission of the data volumes can be individually established by the users of the receiving facility.

An advantageous embodiment of the invention provides that an essentially equal time interval is in each case formed between the times tₖ₋₁ and tₖ (2≦k≦n), which interval is predetermined at the transmitting end, as a result of which the reproduction of the transmitted data units can be continuously begun by the users of the receiving facilities if the time intervals are sufficiently short.

Further developments of the invention are disclosed in the other claims.

### BRIEF DESCRIPTION OF THE DRAWINGS

In the text which follows, the invention will be explained in greater detail with reference to exemplary embodiments and referring to a drawing, in which:

FIG. 1 shows a diagrammatic representation of the variation with time of a transmission of a data stream for a receiving facility;

FIG. 2 shows a diagrammatic representation of the variation with time of a transmission of the data stream for two receiving facilities;

FIG. 3 shows a diagrammatic representation of the variation with time of a transmission of the data stream for one or two receiving facilities which in each case have limited storage capacity;

FIG. 4 shows a diagrammatic representation of a first transmission schedule for a transmitting facility for transmitting the data stream;

FIG. 5 shows a diagrammatic representation of a second transmission schedule for the transmitting facility for transmitting the data stream;

FIG. 6 shows a diagrammatic representation of a third transmission schedule for the transmitting facility for transmitting the data stream;

FIG. 7 shows a diagrammatic representation of the variation with time of a transmission of the data stream for one or two transmitting facilities, the transmission being interrupted for a period tU;

FIG. 8 shows a diagrammatic representation of a number of data units of a multimedia data stream;

FIG. 9 shows a diagrammatic representation of a further transmission schedule, some of the data units being transmitted in advance.

### DETAILED DESCRIPTION OF THE PREFERRED EMBODIMENTS

A multimedia data stream, for example a feature film, is to be transmitted to an arbitrary number of receiving facilities or, respectively, receivers Eₒ . . . . Eⱼ (j≦1). After it has been received, the feature film is reproduced with the aid of replay means, for example with the aid of a television set or a computer-based monitor and an associated loudspeaker device, which is in each case included in the receiving facilities Eₒ . . . Eⱼ or is connected to those in such a manner that the received feature film can be forwarded to the respective television set. In this arrangement, the multimedia data stream (feature film) is (potentially) replayed continuously, i.e. without interruption.

It is assumed by way of example that the data stream containing the feature film to be transmitted can be divided into x data units Dₓ (x=1,2, . . . ), each of the x data units Dₓ comprising at least one data bit and preferably essentially the same amount of data. In principle, the data units Dₓ are transmitted by the transmitting facility at a transmitting time t^{S}ₓ, received by one of the receivers at a receiving time t^{E}ₓ and reproduced with the aid of associated replay means at a replay time t^{W}ₓ. To simplify the following representation of the method, the following assumption is made for a data unit Dₙ (1≦n≦x): tₙ=t^{S}ₙ=t^{E}ₙ=t_{W}ₙ. In fact, however, the receiving time t^{E}ₙ of the data unit Dₙ is later than the transmitting time t_{S}ₙ, the time interval between t^{S}ₙ and t^{E}ₙ depending on the parameters of the transmission between the transmitting facility and the respective receiving facility. Depending on the transmission medium selected, the transmission delay can be constant or can vary, the latter being the case, for example, in IP networks. If the transmission delay varies, a fixed upper limit of the transmission delay can be assumed to simplify matters, or this upper limit can be repeatedly determined dynamically. The replay time t^{W}ₙ of the data unit Dₙ is also displaced by a finite time after the receiving time t^{E}ₙ since the data unit Dₙ, after having been received, must be forwarded to the replay means and converted (several times) for the purpose of reproduction.

In the description following, it is assumed, as a rule, that the transmission begins at time tₙ for a receiving device. However, it is also possible that the transmission beginning at time tₙ takes place in parallel for a number of receiving facilities, i.e. a number of receiving facilities are “switched in” at time tₙ. In this case, the transmitting facility sends out data units which are received by an arbitrary number of receiving facilities. In this arrangement, it can be provided that the data units are transmitted by a number of transmitting facilities. For example, it is provided that, in this case, the individual transmitting facility in each case only sends, once or several times, a particular subset of the data units of the data stream.

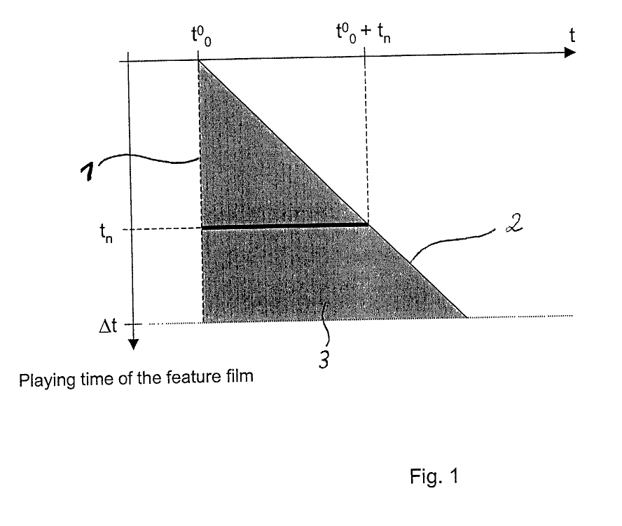

According to FIG. 1, a total time Δt is needed for replaying the feature film, i.e. all x data units Dₓ by means of the television set. During this process, the data unit Dₙ is transmitted at a time tₙ after the beginning of the transmission (transmitting, receiving, replaying). This means that the data unit Dₙ must be transmitted/received and available for replaying at time tₙ after the beginning of the replay (or the reception).

The transmission to a receiving facility Eₖ can begin at a time t⁰ₖ (k=0, 1, . . . ). According to the above assumption (tₙ=t^{S}ₙ=t^{E}ₙ=t^{W}ₙ), the transmission, the reception and the replaying begin at time t⁰ₖ. From this time on, the receiver Eₖ (potentially) receives all data units Dₓ belonging to the feature film. This is illustrated in FIG. 1 by means of an entry line 1.

To be able to reproduce the data units Dₙ in the manner corresponding to the course of the feature film, it is necessary that the data unit Dₙ must be transmitted at the latest at time (t⁰ₖ+tₙ) after the beginning of the transmission of the feature film. If the replaying of the feature film is uninterrupted, the latest transmission times tₙ of the data units for the receiver Eₖ will produce a replay line 2 which begins at (t⁰ₖ, 0) and ends at (t⁰ₖ+Δt, Δt) (compare FIG. 1).

The replay line 2 and the entry line 1 together (with a line t=Δt) form a triangle, a so-called receiving funnel 3 of the receiver Eₖ. All data units Dₓ of the feature film must be transmitted to the receiver Eₖ within this receiving funnel 3 for the receiver Eₖ or its associated replay means to be able to display the feature film completely and continuously.

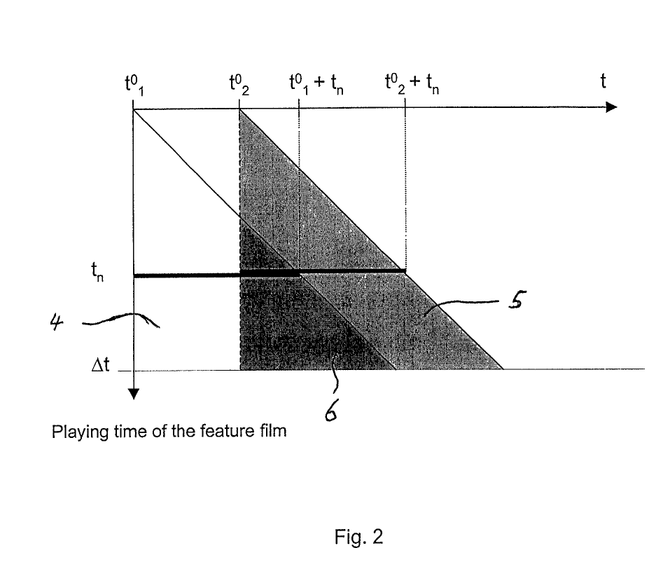

If the feature film, i.e. the data units Dₓ are transmitted by the transmitting facility for two receivers E₁ and E₂ (compare FIG. 2), the receiver E₂ beginning reception at an entry time t⁰₂ before the transmission of the feature film, begun at entry time t⁰₁, for the receiver E₁ which is already active has concluded, the receiving funnels 4, 5 of the two receivers E₁ and E₂ overlap. If the data unit Dₙ of the feature film is transmitted at a time within an overlap area 6, this data unit Dₙ only needs to be transmitted once if both receivers E₁ and E₂ are capable of temporarily storing the data unit Dₙ in respective storage means up to their respective transmission time (t⁰₁+tₙ and, respectively t⁰₂+tₙ)—the transmitting, receiving and replay time according to the above assumption. This saves the bandwidth otherwise needed for the individual transmission to the two receivers E₁ and E₂. In principle, the data unit Dₙ is only temporarily stored if the data unit Dₙ is transmitted before the time at which the data unit Dₙ is to be replayed in the course of the feature film.

The exemplary procedure described shows that a first data set M₁ which is transmitted to the receiver E₁ or an arbitrary number of other receivers which also opt in at time t⁰₁, for the purpose of transmitting the feature film, comprises all data units Dₓ of the data stream or feature film, respectively. A second data set M₂ which is transmitted for the receiver E₂ or an arbitrary number of other receivers which also opt in at time t⁰₂, beginning at time t⁰₂, however, only comprises some of the data units Dₓ since the receiver E₂ receives, from time t⁰₂ onward, in addition to the data set M₂ intended for this receiver E₂ also the data units of the data set M₁ which are transmitted after time t⁰₂.

On the basis of the representation of the method for two receivers E₁ and E₂, the method described can be expanded to a multiplicity of receivers E₀ . . . Eⱼ (j≦1). In this connection, two basic variants are possible which can also be combined with one another:

1. Utilization of a return channel

Each of the receivers E₀ . . . Eⱼ (j≧1) informs the transmitting facility via an (interactive) return channel about which programme (media content) it wishes to receive at what time. In the example described above, this means that the receivers inform about the time from which the feature film is to be transmitted for the respective receiver. In this manner, each receiver Eₖ establishes an associated time t⁰ₖ for the beginning of the transmission. From the incoming request of the receivers E₀ . . . Eⱼ, the transmitting facility calculates a transmission schedule which describes the order in which data units Dₓ are to be transmitted in order to be transmitted in each case in the largest possible number of receiving funnels of the receivers.

2. Transmission without return channel

If no return channel is available between the transmitting facility and the receivers E₀ . . . Eⱼ or if the number of receivers becomes too large for individual transmission to be possible, the transmitting facility can establish, instead of the times t⁰ₒ . . . t⁰ⱼ requested by the receivers for the respective beginning of transmission, a predetermined pattern of times for the beginning, for example times at intervals of ten seconds, one minute etc. A receiver then waits until the next predetermined entry time, which is found in the transmitted data stream, and begins replaying only then so that in this case the timing pattern times predetermined by the transmitting facility form or establish the time t⁰₀ . . . t⁰ⱼ (j≧1)

In both cases, the transmitting facility can determine the time to which the data stream (feature film) can be called up at a maximum, i.e. at which the last transmission request by the receivers may be received which will still be met.

Independently of the availability of one or more return channels, the number of receivers, the regularity of the entry times t⁰₀ . . . t⁰ⱼ, the length of the data stream (feature film), the transmitting facility must meet the following requirements when generating and/or dynamically adapting the transmission schedule for the data units Dₓ. In principle, the following applies in conjunction with the receiver Eₖ with the entry time t⁰ₖ, which is one of the several receivers E₀ . . . Eⱼ having different entry times t⁰₀ . . . t⁰ⱼ:

(a) All data units which are transmitted due to another receiver (E₀ . . . Eₖ₋₁, Eₖ₊₁ . . . Eⱼ) within the receiving funnel of Eₖ, do not need to be transmitted again for Eₖ. In this context, a transmission within the receiving funnel of Eₖ means that a data unit Dₙ is transmitted within an interval [t⁰ₖ; t⁰ₖ+tₙ].

(b) A data unit Dm which is not transmitted according to (a) must be transmitted at the latest at time (tok +tm) for Ek -so that it can be replayed in accordance with the time sequence of the feature film.

For two receivers E₁ and E₂ (compare FIG. 2), the transmission bandwidth is optimally utilized if as many of the data units as possible are transmitted within the two transmission funnels 4, 5, that is to say, in this case, as “close to or along” the replay line of E₁ as possible since all these data units only need to be transmitted once.

At the receiver end, a receiver Eₖ proceeds as follows from the beginning of reception of the data stream, i.e. of the data units: Data unit Dₙ, which is to be transmitted during the transmission of the data stream at time tₙ, is transmitted (sent, received) at an arbitrary time tₓ and

i) transferred to the associated replay facility if tₓ=tₙ;

ii) stored in storage means of the receiver Eₖ if tₓ<tₙ, i.e. the data unit Dₙ is needed for replay at a later time and the data unit Dₙ is not yet present in the storage means;

iii) discarded if tₓ>tₙ, i.e. the data unit Dₙ is no longer significant for replay at time tₓ or is already present in the storage means.

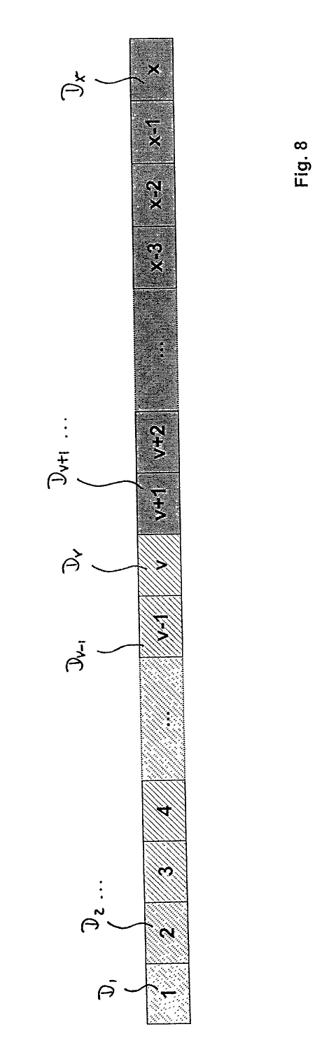

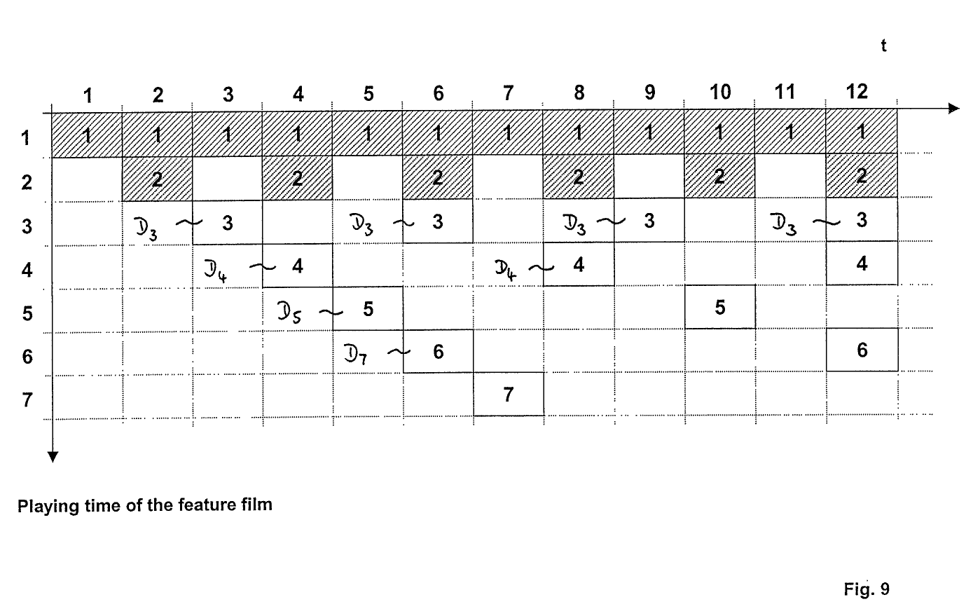

In addition, data unit Dₙ is taken out of the storage means at time tₛ and transferred to the replay facility if tₛ=tₙ and the data unit Dₙ has been stored according to ii) or transmitted in advance or distributed (compare description for FIGS. 8 and 9). In receivers E₀ . . . Eⱼ, storage space is thus needed (potentially in the form of a hard disc) on which the data units received and not needed as yet are temporarily stored until the time for replay has come.

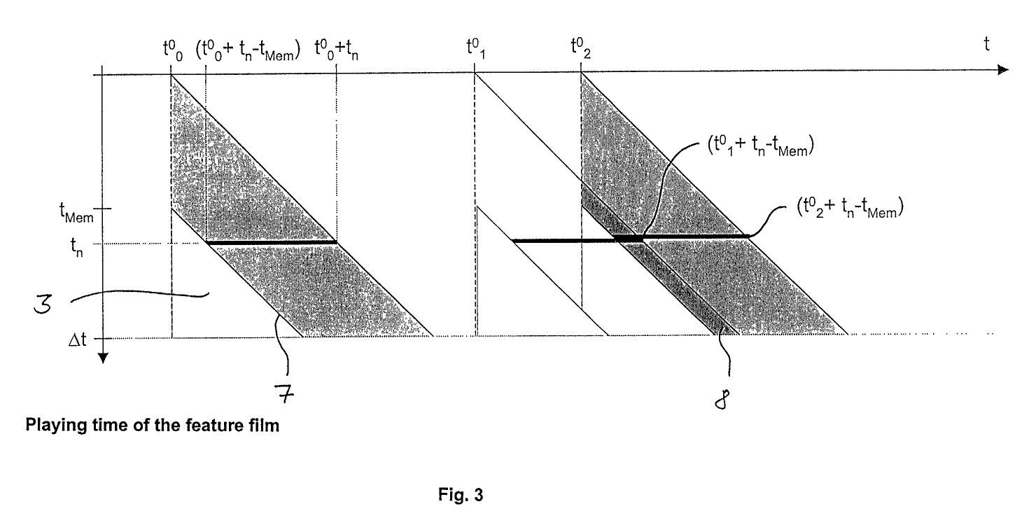

As a rule, receivers E₀ . . . Eⱼ only have a finite storage capacity. If the volume of the data units Dₓ to be temporarily stored at a time is greater than the available storage capacity—for instance if only a maximum of ten minutes of the feature film can be stored at a time—the requirements for the transmitting facility and the receivers E₀ . . . Eⱼ are changed. The receiving funnel 3 is restricted by a storage boundary line 7 (compare FIG. 3). Data units, the replay time of which is too far in the future in the case of an early transmission, are not yet stored on reception. Instead, the system waits for a retransmission at a later time.

For a receiver Eₖ with the entry time t⁰ₖ, which is one of E₀ . . . Eⱼ receivers with different entry times too t⁰₀ . . . t⁰ₙ, a memory limitation to a period t_{Mem} has the following result:

(a) All data units which are transmitted within the modified receiving funnel of Eₖ due to another receiver (E₀ . . . Eₖ₋₁, Eₖ₋₁ . . . Eₙ) do not need to be transmitted again for Eₖ. A transmission within the receiving funnel of Eₖ means that a data unit Dₙ is transmitted in the interval at the earliest at time t^{o}ₖ and in the interval [t⁰ₖ+tₙ−t_{Mem}; t⁰ₖ+tₙ]

(b) A data unit Dm which has not been transmitted in accordance with (a), must be sent out at the latest at time (t⁰ₖ+t_{Mem}) but not before t⁰ₖ and not before (t⁰ₖ+tₙ−t_{Mem})

At the receiver end, the method changes when the parameter t_{Mem} is taken into consideration. At the beginning of reception of a data stream, the receiving facility of a receiver Eₖ proceeds as follows: the data unit Dₙ which is to be transmitted at time tₙ during the transmission of the data stream, is transmitted (sent, received) at an arbitrary time tₓ, and

i) transferred to the associated replay facility if tₓ=tₙ;

ii) stored in storage means of the receiver Eₖ if tₓ<tₙ and tₓ>tₙ−t_{Mem}, i.e. the data unit Dₙ is needed for replay at a later time which, however, is still within the “range” (storage capacity) of the storage means, and the data unit Dₙ is not yet present in the storage means;

iii) discarded if tₓ>tₙ, i.e. the data unit Dₙ is no longer of significance for replay at time tₓ or is already present in the storage means or (tₓ≦tₙ−t_{Mem}).

In addition, the data unit Dₙ is taken out of the storage means at time tₛ and transferred to the replay facility if tₛ=tₙ and the data unit Dₙ has been stored according to ii) or transmitted in advance or distributed (compare description for FIGS. 8 and 9).

According to FIG. 3, the overlap area 6 of the receiving funnels 3 of the receivers E₁ and E₂ is reduced in the case where the storage capacity of receivers E₁ and E₂ is limited, as characterized by means of t_{Mem}, to a reduced overlap area 8.

The transmitting and receiving rules specified here for this modification of the method only represent one possible example. Whether data units situated at a time which is also further in the future than t_{Mem} can be temporarily stored depends on the actual transmission schedule. Overall, transmitter and receiver only have to jointly take care that the data unit Dₙ is present at the receiver at time tₙ.

Whereas an implementation algorithm can be derived directly in each case from the methods described above for the receiving end, a number of rules can be specified for the transmitting end which must be fulfilled when a transmission schedule is generated for transmitting the data units Dₓ by means of the transmitting facility.

In the text which follows, a possible transmission method which satisfies the above rules and is simple to implement is described by way of example. After that, three procedures for generating a transmission schedule for the data units are described by way of example. Other forms of implementation are also conceivable both for the transmission method and for generating the transmission schedule.

In the exemplary generation of a transmission schedule for the data stream to be transmitted from the transmitting facility to the receivers, the following rules are taken into consideration:

1) The data stream is transformed into a transmittable data stream by dividing the data stream into preferably equally large, mutually delimitable data units Dₓ (x1, 2, . . . ). The data units Dₓ can be as small as required and can comprise even individual bytes or bits in the extreme case. These mutually delimitable data units Dₓ are also called “slots”.

2) The data units Dₓ are in each case transmitted as late as possible, i.e. as close as possible to the replay line of the receivers E₀ . . . Eⱼ so that the data units Dₓ are in the largest possible number of receiving funnels of the receivers E₀ . . . Eⱼ in order to minimize the bandwidths used for the transmission.

3) To achieve a utilization of the transmission medium which is as uniform as possible or, respectively, to avoid temporary overloading, data units can be sent already at an earlier time. This makes it possible to compensate for peak loads but the data unit sent too early may have to be sent again since, with the early transmission, it could be in the receiving funnel of fewer receivers than would be the case if the data unit had not been sent too early. Avoiding peak loads is then in conflict with the minimization of the data volume transmitted overall.

In the text which follows, three examples for the distribution of the data unit Dₓ (transmission schedule) for transmission are specified. It is assumed that all data units Dₓ comprise information of the same duration, i.e. a feature film segment of the same duration in the case of the feature film. At the same time, the duration of one data unit defines the granularity of the entry times t⁰ⱼ (j≧0) for receivers Ej (j≧0). If a data unit lasts ten seconds, a new (virtual) receiver is assumed every 10 seconds in this method without return channel, i.e. new viewers can be added every ten seconds in order to view the feature film from the start. In the representation following, the data units Dₓ (x=1, 2 . . . ) are numbered consecutively.

The embodiments described in the text which follows are only examples. In addition, the method permits:

that the size/duration of the data units is not equal,

that the duration of the data unit and the granularity of the entry times t⁰ⱼ (j≧0) are different and/or

that the entry times t⁰ⱼ (j≧0) can be arbitrarily distributed with and without return channel.

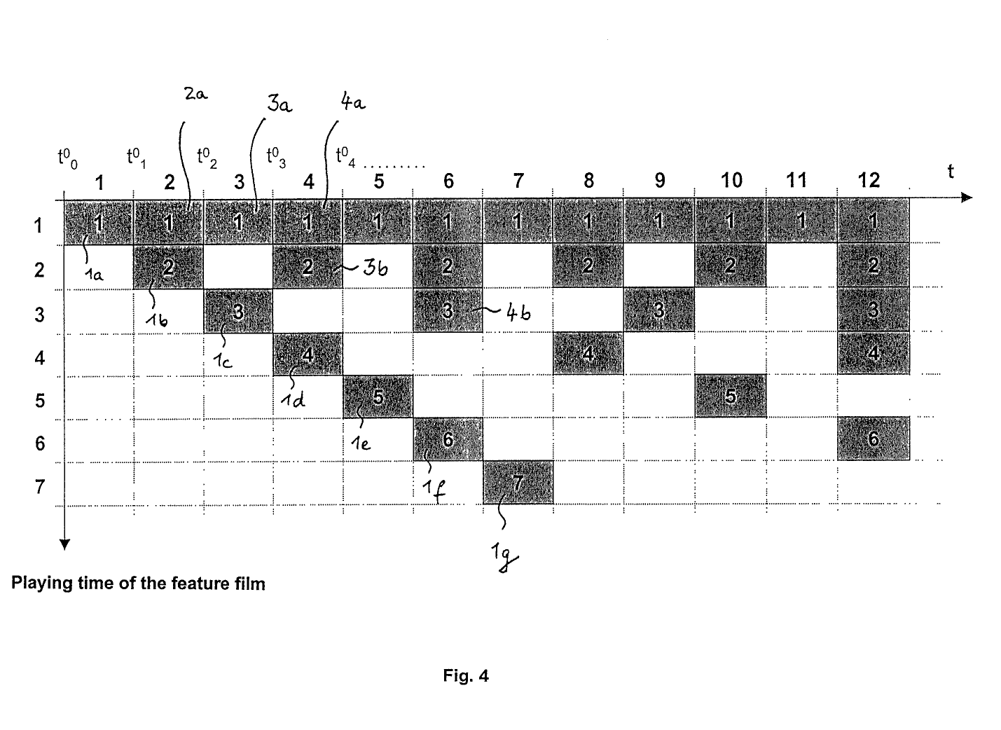

FIG. 4 shows an example of a harmonic transmission schedule, the data stream to be transmitted being subdivided into seven data units D₁ . . . D₇. The time axis is subdivided into intervals of equal length, the intervals corresponding to the duration of the seven data units Dₓ. For the transmission, the data units D₁ . . . D₇ are distributed over the time intervals for the transmission in accordance with a simple rule: data unit Dₙ having consecutive number n is transmitted in every nth interval, i.e. the first data unit D₁ in every interval, the second data unit D₂ in intervals 2,4,6 . . . , the third data unit D₃ in intervals 3,6,9, . . . etc. The possible entry times t⁰ⱼ (j≧0) for receivers Eⱼ (j≧0) are formed by the respective starting times of the intervals (compare FIG. 4).

For a first receiver E₀, a data set M₀ which comprises all seven data units D₁ . . . D₇ is transmitted according to FIG. 4. The data units transmitted for the first receiver are designated by reference symbols 1a to 1g. If a second receiver E₁, for which the data stream is to be transmitted beginning at t⁰₁ is additionally connected at time t⁰₁, a data set M₁ transmitted for the second receiver E₁ only comprises the data unit D₁ which is designated by 2a in FIG. 4. The remaining data units D₂ . . . D₇, which must also be transmitted to the second receiver E₁ to reproduce the data stream for the user of the second receiver E₁, are “taken” from the data set M₀ by the second receiver E₁ beginning at t⁰₁. For the second receiver E₁, therefore, a much smaller number of the data units must be sent so that transmission bandwidth is saved.

If a third receiver E₂, for which the data stream is to be transmitted beginning at t⁰₂, is additionally connected at time t⁰₂, a data set M₂ transmitted for the third receiver E₂ comprises data units D₁ and D₂ which are designated by 3a and 3b, respectively, in FIG. 4. The remaining data units D₃ . . . D₇, which must also be transmitted to reproduce the data stream for the user of the third receiver E₂, are “taken” from the data set M₀ by the third receiver E₂ beginning at t⁰₂, namely D₃ . . . D₇ (1c to 1g in FIG. 4).

If a fourth receiver E₃, for which the data stream is to be transmitted beginning at t⁰₃, is additionally connected at time t⁰₃, a data set M₃ transmitted for the fourth receiver E₃ comprises data units D₁ and D₃ which are designated by 4a and 4b, respectively, in FIG. 4. The remaining data units D₂, D₄ . . . D₇, which must also be transmitted to reproduce the data stream for the user of the third receiver E₂, are “taken” from the data set Mₒ, namely data units D₄ . . . D₇ (1d to 1g), and from data set M₂, namely data unit D₂ (3b in FIG. 4), by the fourth receiver E₃ beginning at t⁰₂.

One or more of the transmitted data units can be included in each case in one or more of the data sets Mⱼ (j≧0) both in the exemplary embodiment described in conjunction with FIG. 4 and in the exemplary embodiments explained in the text which follows.

The harmonic transmission schedule described with reference to FIG. 4 has the disadvantage that the number of data units Dₓ to be sent in a time interval varies greatly. Thus, only one data unit (first data unit D₁) is transmitted in time interval 1, two in intervals 2,3 and 5, three in interval 4 and four in interval 6 (correspondingly continued for later intervals). This leads to peak loads, with the consequence that the transmission capacity from transmitter to the receivers E₀ . . . Eⱼ must be matched to the greatest peak load if the transmission capacity is not utilized for a large proportion of the remaining transmission time.

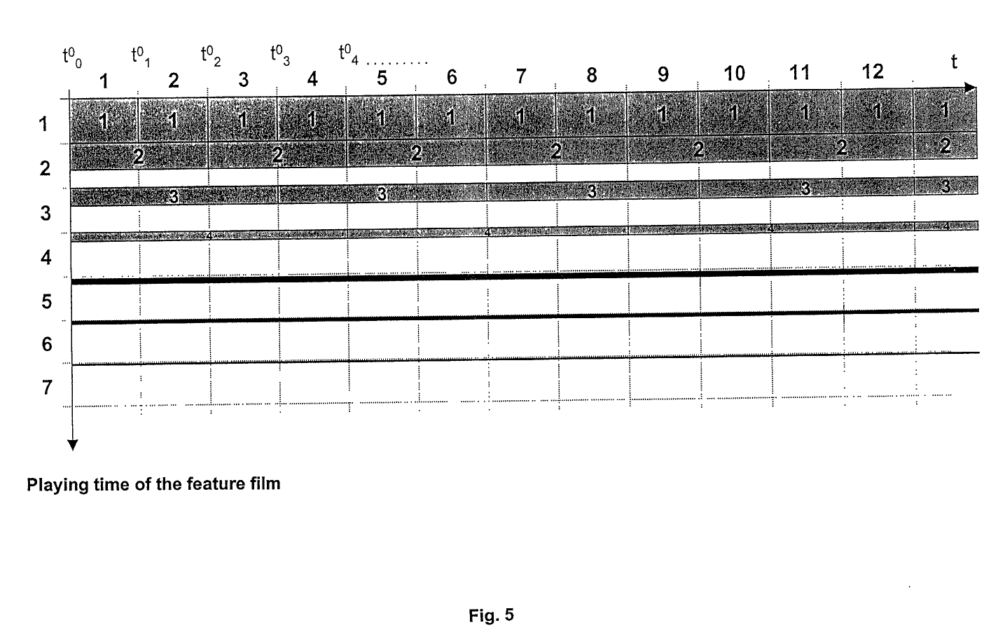

FIG. 5 shows a modification of the method according to FIG. 4 which aims for a more uniform utilization of the transmission medium or transmission capacity, respectively: in each (1+p·n)th interval (p≧0), the system begins to transmit the data unit Dₙ. However, the sending is not concluded in the same interval (except in the case of the first data unit D₁) and, instead, the transmission is distributed to n intervals: the data unit D₁ is transmitted in each interval, and data unit D₂ in intervals 1 to 2, 3 to 4, 5 to 6, . . . , data unit D₃ in intervals 1 to 3, 4 to 6, 7 to 9, . . . . With a uniform distribution of a data unit Dₓ over the time intervals to be utilized, this means that the data unit D₁ is sent with single bandwidth on average, the second data unit D₂ with half the bandwidth on average, the third data unit D₃ with a third of the bandwidth on average etc.—that is to say the mth data unit Dₘ is sent with 1/m of the bandwidth on average which would be needed for transmitting the data unit Dₘ within one time interval. The respective starting times of the intervals again form the entry times t⁰ⱼ (j≧0) for the receivers (compare FIG. 5).

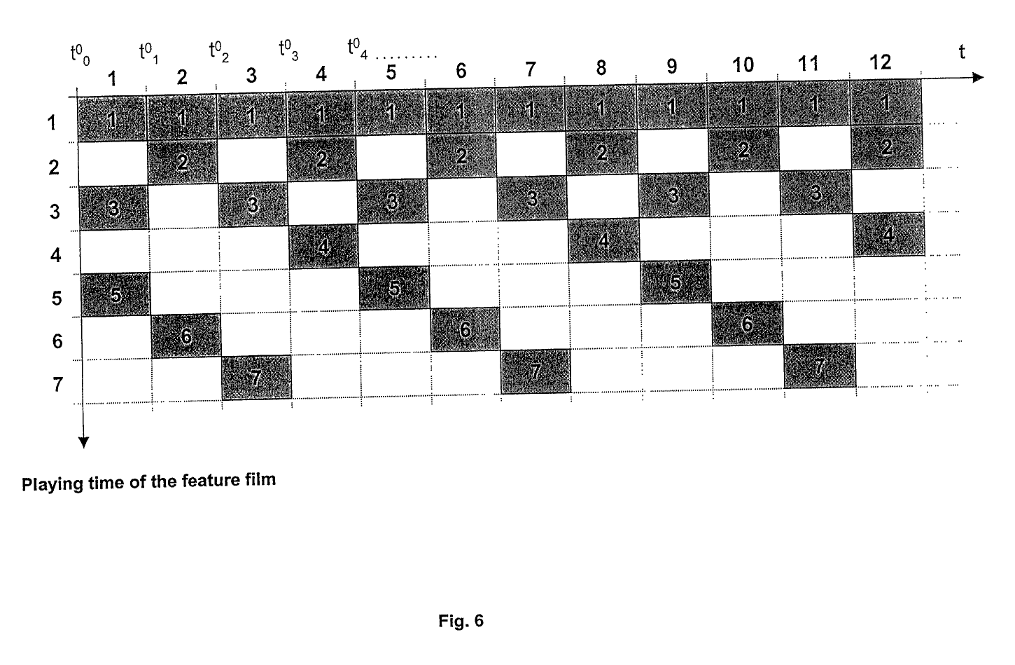

If it is not possible to distribute the transmission of the mth data unit Dₘ (uniformly) over m time intervals due to the technical transmission method and/or the number of data units Dₓ, a comparable effect, although with a slightly increased transmission volume, can be achieved as follows (compare FIG. 6):

if m=2^{z} with z≧0 (i.e. m is a power of two), the mth data unit Dₘ is transmitted in each mth interval (compare FIG. 6).

Otherwise, all mth data units Dₘ for which 2^{z}<m<2^{z+1} with j≧0 holds true, are transmitted precisely once between time intervals 2^{z} and 2^{z+1} and that in any (but uniform) order.

This means that the data units D₁, D₂, D₄ are sent in each, each second, each fourth etc. time interval. The data unit D₃ is in each case sent in the pauses between data units D₂, i.e. in time intervals 1,3,5,7 etc. Data units D₅ to D₇ with consecutive numbers 5 to 7 are sent successively in each case once in the sequence of time intervals in which data unit D₄ is not sent, i.e. in time intervals 1, 2 and 3; 5, 6 and 7; 9, 10 and 11 etc.

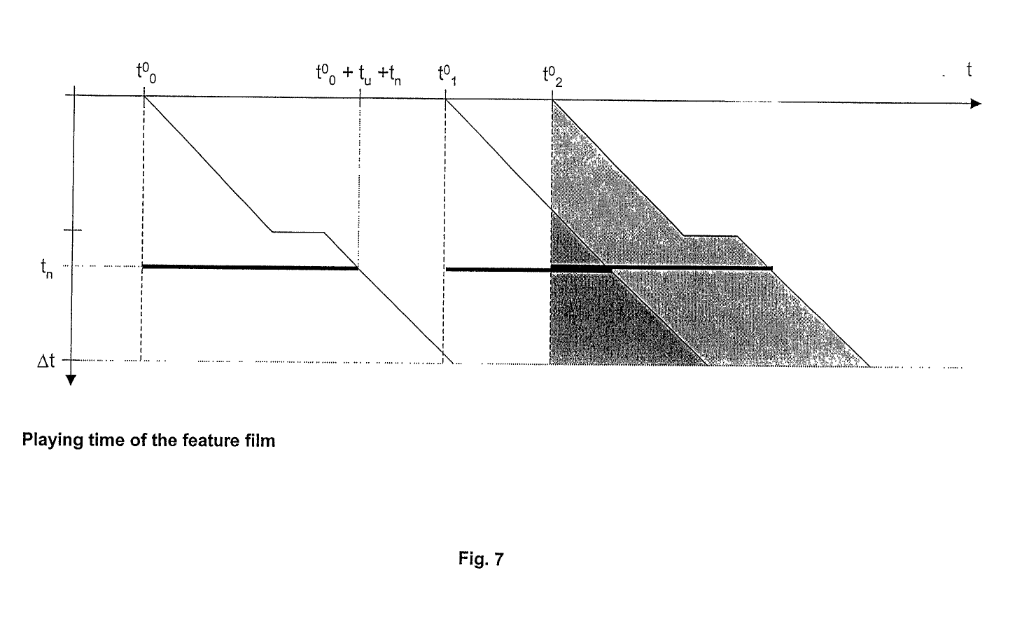

FIG. 7 shows a variation of the receiving funnels in the case where the data stream is transmitted to one or, respectively, to two receivers if the replay of the feature film is interrupted for a time tᵤ and is then continued again. In this case, a distinction can be made between two forms of receivers. In one form of receiver, the data units are still received and stored in the background during the interruption. This then leads to an expanded receiving funnel. In another form of receiver, the data units are not received during the interruption which leads to a displaced receiving funnel. In both cases, the receivers must not discard the data units already stored during the replay interruption.

The method described is based on the fact that data units Dₓ are transmitted in such a manner that the receivers receive all data units Dₓ required for the continuous display of the multimedia data stream, regardless of when they begin to receive them. The various transmission schedules described (compare FIGS. 4 to 6) explain by way of example when and how often a particular data unit Dₓ must be sent in order to meet the requirements of continuous reproduction of the multimedia stream. The result is, in particular, that the first data units D₁ of the multimedia stream are transmitted especially often and thus have a high proportion of the bandwidth required for the method. For a transmission of a two-hour feature film having 7200 equally large data units Dₓ according to the method described, an optimum bandwidth was calculated which corresponds to about 9.45-times the transmitting bandwidth used when this feature film is transmitted in accordance with a conventional simple broadcasting of the feature film. The factor varies depending on the length of the feature film and the number of data units Dₓ.

A further improvement in the method described can be achieved with regard to the average transmitting bandwidth needed, by not transmitting a subset D₁ . . . Dᵥ (1≦v<x) of the data units Dₓ, for example the first 60 seconds of the feature film, in accordance with the method described but by already making it locally available to the receiver, e.g. as a file from which these data units D₁ . . . Dᵥ are read out. In this manner, the required bandwidth can be reduced from the factor of 9.5 to about 4.8 in the abovementioned example.

FIG. 8 diagrammatically shows a multimedia data stream which comprises the data units Dₓ. The multimedia stream comprises a subset of data units D₁, . . . , Dᵥ and a subset of data units Dᵥ₊₁, . . . , Dₓ. The subset of data units Dᵥ₊₁, . . . , Dₓ is transmitted to the receiver or all receivers in accordance with the method described above. At the beginning, the subset of data units D₁, . . . , Dᵥ is distributed to the receiver or all receivers so that the data units D₁, . . . , Dᵥ are present in the receiver or all receivers before the beginning of a reproduction of the multimedia data stream. This reduces the transmission bandwidths needed during the transmission of the subset of data units Dᵥ₊₁, . . . , Dₓ in accordance with the novel method described.

The prior distribution of the subset of data units D₁, . . . , Dᵥ to the receiver or all receivers can be carried out in any manner according to usual methods, for example by means of web prefetching, by means of file distribution (e.g. via satellite), as part of an electronic programme guide, on CDs etc. The predistributed data units D₁, . . . , Dᵥ can be transmitted encrypted when they are distributed.

FIG. 9 diagrammatically shows a transmission schedule similar to the transmission schedule in FIG. 4 for distributing the data units Dₓ. In distinction from the method described in conjunction with FIG. 4, the data units D₁ and D₂ are at first not distributed to the receiver/s in accordance with the transmission schedule shown which is why they are drawn shaded. The further data units Dᵥ₊₁ (v≧1) are then transmitted to the receiver/s in accordance with the method which was described in conjunction with FIG. 4. In this arrangement, the frequency of transmission of the further data units Dᵥ₊₁ and their order in time within the transmission schedule correspond to the position, in each case identified by means of the index v+1, of the further data units Dᵥ₊₁ (v≧1) in the data stream of the data units Dₓ (compare FIG. 9). This correspondingly applies when the further data units Dᵥ₊₁ (v≧1) are transmitted in accordance with the transmission schedules diagrammatically shown in FIGS. 5 or 6.

In the previous representation, it is assumed that all data units Dₓ of a feature film are always received by all receivers (which have begun to view the feature film) and that the receivers discard the data units which they do not need. In particular, all receivers are in this case considered to be equal, especially with respect to

the receiving bandwidths demanded by them and

the number of entry points t⁰ₖ offered to them (if no return channel is available).

This means all data units Dₓ of a feature film are transmitted in the same transmission channel and reach all receivers in this one transmission channel. However, different feature films are potentially transmitted in different transmission channels. This procedure is analogous to radio and television where different transmitters also use different transmission channels (in this case transmitting frequencies).

A distinction between different channels for different feature films/programmes can in this case assume any conceivable form: transmitting frequencies, time slices in frequencies, frequency ranges, bit and/or byte positions in continuous data streams and in data packets, network and/or transport addresses (for ATM, IP and any other networks) etc. These possibilities for implementing the discrimination between different channels similarly applies to the subchannels presented in the text which follows.

Subdivision into Main Channels and Subchannels

To be able to make the requirements for the receivers more heterogeneous and possibly to be able to offer different performances in conjunction therewith or as a supplement, the transmission of a feature film/programme in a channel can be conceivably supplemented by further substructuring of this channel into subchannels per feature film/programme.

In this case, not all data units D, (slots) are sent in the same channel (the main channel) but distributed over a number of subchannels in accordance with the objectives. Among others, the following application scenarios can be implemented in this manner:

a) Customer-Oriented Advertising

A feature film is sprinkled with a number of advertising blocks W₁ to Wₙ distributed over its playing time. Such an advertising block Wₖ needs data units D_{k,1} to D_{k,m} for its transmission. If only one type of advertising is sent for the entire public, the advertising blocks are transmitted as part of one transmission channel. If the various types of advertising (per advertising block) are to be distinguished, the respective data units are sent out in different subchannels. Each receiver selects one or more additional channel in addition to the main channel:

| Channel | Data units (slots) |
|---|---|
| Main channel | Content of the feature film |
| Subchannel 1 | “Sports” advertising |
| Subchannel 2 | “Alcoholic drinks” advertising |
| . . . | |
| Subchannel w | “Domestic” advertising |

Advertising is only one example here. Insertions of other types of information (for example short news, (regional) traffic information, different parts of a feature film (for example censored/uncensored etc.) can be implemented by using the same mechanism.

b) Different Versions of a Feature Film (Happy End Versus Tragic End)

After a certain time t_{E} in the film (all data units Dₓ with x>E), different contents are sent out in different channels. Each receiver individually decides which one of these channels he wishes to view.

| Channel | Data units (slots) |
|---|---|
| Main channel | Content of the feature film up to D_{E} |
| Subchannel I | Data units Dₓ with x > E for “happy |
| | end” |
| Subchannel II | Data units Dₓ with x > E for “tragic |
| | end” |
| Subchannel III | Data units Dₓ with x > E for “surprise |
| | end” |

In this case, attention should be paid especially to the fact that a combination of the transmission of various endings by means of the invention leads to only an overproportionally smaller part of additional information having to be sent. According to the transmission schedules presented by way of example, data units with contents which are at the end of a feature film are transmitted distinctly more rarely than those with contents at the beginning of the feature film.

c) Simple Feature Film Transmission Compared With One Expanded According to the Invention

The transmission of the data contents can be designed in such a manner that, on the one hand, simple receivers (i.e. those not expanded according to the invention) can receive and reproduce the feature film, but only at the predetermined starting time of the first transmission t⁰₀, and, on the other hand, receivers according to the invention can begin viewing the feature film at different times.

To this end, for example, only the initial transmission of the feature film takes place on the main channel and each data unit is transmitted exactly once in succession. On another channel (here called subchannel I), the supplementary information is transmitted according to the invention. Simple receivers only receive the main channel, extended receivers, on the other hand, also receive the supplementary channel.

It is conceivable to transmit the feature film repeatedly completely in the main channel (for example in 2-hourly cycles).

| Channel | Data units (slots) |
|---|---|
| Main channel | Transmit content of feature film once |
| | like normal broadcasting/normal |
| | television (data units 1a, 1b, . . . , 1g |
| | from FIG. 4 if transmission according |
| | to the method shown in FIG. 4) |
| Subchannel I | Supplementary information necessary for |
| | implementing the invention (all other |
| | data units from FIG. 4) |

This method cannot only be used for supporting conventional receivers; a combination with data encryption, for example, is also conceivable. Thus, the main channel, for instance, can be transmitted unencrypted and thus is accessible to everybody but the subchannel is encrypted. A receiver without knowing the key can then only view the feature film at the first entry point but a receiver having knowledge of the key, in contrast, can start at any time and still view the feature film from the start. This makes it possible to create different models for different groups of customers in a simple manner (see also next section).

d) Different Granularity of Entry Times

In extension of section c), the granularity of the entry points can also be adjusted by using different transmission channels. For example, as described in section c), the feature film can be transmitted only once in a main channel, the necessary supplementary information for being able to enter into the feature film every 10 minutes on subchannel I, the supplementary information for being able to begin viewing every minute on subchannel II etc. Naturally, any other combinations are also conceivable here.

| Channel | Data units (slots) |
|---|---|
| Main channel | Transmit content of the feature film |
| | once like normal broadcasting/normal |
| | television (data units 1a, 1b, . . . , 1g |
| | from FIG. 4 if transmission according |
| | to the method shown in FIG. 4) |
| Subchannel I | Supplementary information for entry |
| | points every 10 minutes |
| Subchannel II | Supplementary information for entry |
| | points every minute |

e) Different Video Quality (Layered Coding)

Finally, a technique is known which divides the content of a multimedia stream over different substreams: A basic data stream provides the basis for the viewing, supplementary data streams provide additional quality. Such methods are called “layered coding” and are known in various forms, especially from video data compression. It is possible here to offer for example different (temporal and spatial) resolutions of a video film, for example 15 fps (frames per second), 352×288, in the basic channel, 30 fps with a resolution of 352×288 pixels in the first supplementary channel, 30 fps with a resolution of 704×576 pixels in the second supplementary channel etc. They can be used as a supplement to the invention and used in any combination with the abovementioned divisions into subchannels.

In the example following, only a mono-audio signal and a black/white picture is transmitted in the main channel, subchannel I supplies stereo sound and colour, subchannel 2 supplies HDTV quality and surround sound. Such an application can be appropriate, e.g. in the case of pay-TV programmes to offer different qualitative gradings of a film.

| Channel | Data units (slots) |
|---|---|
| Main channel | Black/white picture, mono-audio |
| Subchannel I | Colour picture, stereo sound |
| Subchannel II | HDTV quality, surround sound |

It should also be noted that, in principle, all the above scenarios can also be implemented without subdivision into various channels and subchannels, in that the transmitted data units are identified in accordance with the respective content and the receivers then only evaluate the contents desired by the consumer or, respectively, those which they are able to evaluate. However, the concept of the channels additionally provides greater efficiency and permits the heterogeneity of the receivers with respect to their receiving bandwidths initially mentioned.

Fault-Tolerant Transmission

In packet-switched networks, packet losses may occur. These are primarily dependent on the dimensioning of the network (bandwidths of the links) and the performance of the routers used. Whereas packet loss rates of 10%-20% or more occur today in the Internet, which virtually does not make it appear to be realistic to transmit high-quality media streams, well-administered networks which are self-contained (such as satellite links, cable networks, intranetworks etc.) provide an environment with almost lossless data transmission.

Here, too, however, the occasional loss of one or more data units cannot be completely ruled out. For this reason, mechanisms must be provided which restore data units lost during their actual transmission in time at the receiver(s) before they have to be replayed.

Overall, there are two different methods, both of which can be combined with the invention:

If a return channel is available, the receivers can request missing data units again from the transmitter which then retransmits them. To detect missing data units, the data units must be numbered in the transmission schedule, for example in accordance with the order in which they are transmitted, or otherwise identified in such a manner that a receiver is capable of

detecting a missing data unit (even if it is only to be reproduced in the remote future),

determining, if necessary, whether the missing data unit is not transmitted at least one more time by the transmitter before the time of reproduction, in any case (so that no further action is required from the receiver) and

if necessary, requesting the retransmission of the missing data unit from the transmitter,

potentially independently of the transmission schedule used by the transmitter at a time.

It must be noted here that in this variant of error correction, transmitting, receiving and reproduction time of a data unit are separated. In particular, an additional (artificial) delay can be inserted between reception and reproduction in order to ensure that data units, the transmission of which has taken place close to their reproduction time (applicable without additional delay) are still available in time for reproduction when they have to be retransmitted.

Independently of whether a return channel is available or not, the transmitted data units can be enriched by redundant supplementary information. If then a data unit is lost during a transmission, it can be reconstructed from the remaining data units and/or the redundant information with a probability dependent on the method and/or the quantity of redundant information used. Such methods are called forward error correction (FEC). In the simplest case, each data unit is sent several times. More complex methods send for k data units (n-k) redundant units which are generated in such a manner that from n transmitted information units n-k can get lost and the content can still be completely reconstructed. Various other methods and combinations of different methods are also conceivable.

It should also be noted here that receiving and reproduction time can be separate if the receiver must still wait, if necessary, for the arrival of the redundant units (potentially sent later) before the media content can be replayed.

This, too, may be done by utilizing channels and subchannels: thus, the retransmissions can be transmitted, for instance, in a separate subchannel and different (preferably complementary) sets of FEC data can be sent in different subchannels.

The features of the invention disclosed in the above description, the drawing and the claims, can be of significance for the realization of the invention in its various embodiments both singly and in any combination.

What is claimed is:

1. A method for transmitting data units of a data stream, especially a multimedia data stream, from at least one transmitting facility to at least one receiving facility Eⱼ (j≧1), in which method:
n data sets (n≧2) are sent with the aid of the at least one transmitting facility,
the sending of a first data set M₁ of the n data sets begins at a time t₁,
the first data set M₁ comprises all data units of the data stream,
the sending of at least one further data set Mₖ (2≧k≧n) of the n data sets begins at a time tₖ (2≧k≧n),
the at least one further data set Mₖ comprises at least one part of the data units of the data stream, and
the n data sets are sent in such a manner that in the at least one receiving facility Eⱼ, a reproduction of the data units of the data stream as predetermined time sequence of information, especially picture and/or sound information, can be begun at a starting time tₖ^{A}=tₖ+0 (θ>0) and ended at an ending time tₖ^{E}=tₖ^{A}+Δt, where θ is a period characteristic of the transmission of individual data units of the data stream from the at least one transmitting facility to the at least one receiving facility Eⱼ and/or processing of individual data units of the data stream and Δt is a period characteristic of the reproduction of all data units of the data stream as the predetermined time sequence of information,
wherein the at least one further data set Mₖ (2≦k≦n) is formed from selected data units of the data stream for which an earlier transmission is begun at least once by the at least one transmitting facility in a time interval between a time tₖ₋₁ and the time tₖ (2≦k≦n), a time interval (tₖ₋₁−tₖ) being smaller than Δt for at least two of successive times tₖ and tₖ₊₁ (1≦k≦n).

2. The method according to claim 1, wherein an input of a user of the at least one receiving facility Eⱼ for establishing the time t₁ and/or the time tₖ (2≦k≦n) is electronically detected, the input being transmitted to the at least one transmitting facility via a return data channel formed between the at least one transmitting facility and the at least one receiving facility Eₘ.

3. The method according to claim 1, wherein the time t₁ and/or the times tₖ (2≦k≦n) are predetermined at the transmitting end.

4. The method according to claim 1, wherein an essentially equal time interval is formed in each case between the times tₖ₋₁ and tₖ (2≦k≦n).

5. The method according to claim 1, wherein the data stream comprises x data units Dₓ (x=1,2, . . . ), the transmitting between the at least one transmitting facility and the at least one receiving facility Eⱼ (j>1) is performed over a predetermined period which is divided into time intervals Δt_{y} (y=1,2, . . . ), an mth data unit Dₘ (1≦m≦x) being transmitted within each mth time interval Δtₘ.

6. The method according to claim 1, wherein the data stream comprises x data units Dₓ (x=1,2, . . . ), the transmitting between the at least one transmitting facility and the at least one receiving facility Eⱼ (j≧1) is performed over a predetermined period which is divided into time intervals Δt_{y} (y=1,2, . . . ), the sending of an mth data unit Dₘ (1≦m≦x) being begun within each (1+p·m)-th time interval Δt₁₊ₚₘ (p≧0) and extending over m time intervals Δt₁₊ₚₘ+ . . . +Δtₘ₊ₚₘ.

7. The method according to claim 1, wherein the datastream comprises x data units Dₓ (x=1,2, . . . ), the transmitting between the at least one transmitting facility and the at least one receiving facility Eⱼ (j≧1) is performed over a predetermined period which is divided into time intervals Δt_{y} (y=1,2, . . . ), all mth data units Dₘ (1≦m≦x) being sent in each mth time interval Δtₘ when m=2^{p} (p=0, 1, 2, 3, . . . ) and all hth data units Dₕ (1<h≦x), for which 2^{k}<h<2^{z+1} (z≧0), exactly once between the 2^{z}th time interval and the 2^{z+1}th time interval.

8. The method according to claim 5, wherein the data units Dₓ of the data stream of a total data stream are comprised of data units D_{x*} (x*=v+x; v≧1), where v is a number of data units D_{x*} of the total data stream which are conveyed to the at least one receiving facility Eⱼ before the time t₁ so that the following holds true when the mth data unit Dₘ is sent:
v<m≦x*.

9. The method according to claim 6, wherein the data units Dₓ of the data stream of a total data stream are comprised of data units D_{x*} (x*=v+x; v≧1), where v is a number of data units D_{x*} of the total data stream which are conveyed to the at least one receiving facility Eⱼ before the time t₁ so that the following holds true when the mth data unit Dₘ is sent:
v<m≦x*.

10. The method according to claim 7, wherein the data units Dₓ of the data stream of a total data stream are comprised of data units D_{x*} (x*=v+x; v≧1), where v is a number of data units D_{x*} of the total data stream which are conveyed to the at least one receiving facility Eⱼ before the time t₁ so that the following holds true when the mth data unit Dₘ is sent:
v<m≦x*.

11. The method according to claim 1, wherein a data unit D^{E}ₓ (x=1,2, . . . ) of the data stream which is received by the at least one receiving facility Eⱼ is reproduced with the aid of replay means at a replay time t^{W}ₓ (x=1,2, . . . ) within the predetermined time sequence of information items, an mth data unit Dₘ of the data stream being sent in such a manner that an mth received data unit D^{E}ₘ (1≦m≦x) comprising the transmitted mth data unit Dₘ is received by the at least one receiver facility Eⱼ closely in time to a replay time t^{W}ₘ.

12. The method according to claim 1, wherein a data unit D^{E}ₓ (x=1,2, . . . ) of the data stream which is received by the at least one receiving facility Eⱼ is reproduced with the aid of replay means at a replay time t^{W}ₓ (x=1,2, . . . ) within a predetermined time sequence of information items, an mth received data unit D^{E}ₘ (1≦m≦x) received at a receiving time t_{E} being
a) transferred to the replay means when t_{E}=t^{W}ₘ−ε(ε>0), where ε is a characteristic time for transferring the mth received data unit D^{E}ₘ to the replay means and/or a conversion of the mth received data unit D^{E}ₘ for reproduction; or
b) stored in storage means of the at least one receiving facility Eⱼ if t_{E}<t^{W}ₘ−ε and the mth received data unit D^{E}ₘ is not yet stored in the storage means; or
c) discarded if t_{E}>t^{W}ₘ−ε or the mth received data unit D^{E}ₘ is already stored in the storage means.

13. The method according to claim 1, wherein a data unit D^{E}ₓ (x1,2, . . . ) of the data stream which is received by the at least one receiving facility Eⱼ is reproduced with the aid of replay means at a replay time t^{W}ₓ (x=1,2, . . . ) within a predetermined time sequence of information items, an mth received data unit D^{E}ₘ (1≦m≦x) received at a receiving time t_{E} being
a) transferred to the replay means when t_{E}=t^{W}ₘ−ε (ε≧0), where ε is a characteristic time for transferring the mth received data unit D^{E}ₘ to the replay means and/or a conversion of the mth received data unit D^{E}ₘ for reproduction; or
b) stored in storage means of the at least one receiving facility Eⱼ if (t_{E}<(t^{W}ₘ−ε)<(t_{E}+Δt_{Mem})) and the mth received data unit D^{E}ₘ is not yet stored in the storage means, where Δt_{Mem} is a characteristic period for the reproduction of a part of the received data units D^{E}ₓ and the storage capacity of the storage means is limited to the part of the received data units; or
c) discarded if t_{E}>t^{W}ₘ−ε or the mth received data unit D Em is already stored in the storage means.

14. The method according to claim 1, wherein a data stream is at least partially transmitted as encrypted data stream.

15. The method according to claim 14, wherein the first data set M₁ and the at least one further data set Mₖ (2≦k≦n) of the n data sets are transmitted in such a manner that during the reproduction of the data units in the at least one receiving facility Eⱼ, data units which are transmitted unencrypted are reproduced for a predetermined starting period after the starting time tₖ^{A}=tₖ+θ (θ>0).

16. Transmitting device for transmitting data units of a data stream, especially a multimedia data stream, to at least one receiving facility Eⱼ (j≧1), comprising transmitting means for transmitting the data units and control means for controlling the transmitting means, in such a manner that the data units of the data stream can be transmitted from at least one transmitting facility to at least one receiving facility Eⱼ (j≧1), in which method:
n data sets (n≧2) are sent with the aid of the at least one transmitting facility,
the sending of a first data set M₁ of the n data sets begins at a time t₁,
the first data set M₁ comprises all data units of the data stream,
the sending of at least one further data set Mₖ (2≦k≦n) of the n data sets begins at a time tₖ (2≦k≦n),
the at least one further data set Mk comprises at least one part of the data units of the data stream, and
the n data sets are sent in such a manner that in the at least one receiving facility Eⱼ, a reproduction of the data units of the data stream as predetermined time sequence of information, especially picture and/or sound information, can be begun at a starting time tₖ^{A}=tₖ+θ (θ>0) and ended at an ending time tₖ^{E}=tₖ^{A}+Δt, where θ is a period characteristic of the transmission of individual data units of the data stream from the at least one transmitting facility to the at least one receiving facility Eⱼ and/or processing of individual data units of the data stream and Δt is a period characteristic of the reproduction of all data units of the data stream as the predetermined time sequence of information,
wherein the at least one further data set Mₖ (2≦k≦n) is formed from selected data units of the data stream for which an earlier transmission is begun at least once by the at least one transmitting facility in a time interval between a time tₖ₋₁ and the time tₖ (2≦k≦n), a time interval (tₖ₋₁−tₖ) being smaller than Δt for at least two of successive times tₖ and tₖ₊₁ (1≦k≦n).

17. The transmitting device according to claim 16, wherein the transmitting means comprise at least two transmitters for transmitting the data units, the two transmitters being controllable with the aid of the control device in such a manner that a part of the data stream can be sent via one of the at least two transmitters and another part of the data stream can be sent via another one of the at least two transmitters.

18. The transmitting device according to claim 17, wherein the one part of the data stream comprises at least one data unit D_{b} (b <x) of the x data units Dₓ (x=1,2,3, . . . ) and the other part of the data stream comprises data units D₁, . . . , D_{b-1}, D_{b+1}, . . . , Dₓ of the x data units Dₓ.
